(19) United States
(12) Patent Application Publication
(10) Pub. No.: US 2023/0252262 A1
(43) Pub. Date: Aug. 10, 2023

(54) SYSTEM AND METHOD FOR MANAGEMENT OF NEURAL NETWORK MODELS

(71) Applicant: OZYEGIN UNIVERSITESI, Istanbul (TR)

(72) Inventor: Ismail ARI, Istanbul (TR)

(73) Assignee: OZYEGIN UNIVERSITESI, Istanbul (TR)

(21) Appl. No.: 18/013,271

(22) PCT Filed: Dec. 30, 2020
(86) PCT No.: PCT/TR2020/051453

§ 371 Date: Dec. 28, 2022

(51) Int. Cl. G06N 3/02

(52) U.S. Cl. CPC G06N 3/02

(57) ABSTRACT

A system is provided. The system includes at least one model server which allows at least one client device to download at least one of pluralities of pre-trained neural network models including pluralities of pre-trained layers in a model database and to upload said models to the model database. Accordingly, the improvement of the system is that a proxy unit, which has at least one processor unit, is provided between said model server and said client devices; said processor unit is configured to realize the steps of accessing the neural network models, in case the client device requests a neural network model, transmitting said neural network model to the client device, in case the client device requests uploading of an edited neural network model, including at least one modified layer where the client device made change, to the model server, uploading only said modified layers to the model database.

### CROSS REFERENCE TO THE RELATED APPLICATIONS

This application is the national phase entry of International Application No. PCT/TR2020/051453, filed on Dec. 30, 2020, the entire contents of which are incorporated herein by reference.

### TECHNICAL FIELD

The present invention relates to systems including at least one model server which allows at least one client device to download at least one of pluralities of pre-trained neural network models including pluralities of pre-trained layers in a model database and which allows uploading of said models to the model database and the methods where said systems are applied.

### BACKGROUND

Neural network models realize description, estimation and classification according to the data received as input. Neural network models can also be described as command lines which are stored in memories which can be read by the computer, and which realize classification, description and estimation, related to the data received as input, when they are executed by the computer.

In the application with number WO2016095117A1, an object identification method formed by pluralities of layers is described. Here, the mentioned method is a neural network model.

As examples to neural network models, deep neural network models, recurrent neural network, convolutional neural network and the hybrid neural networks formed by the combinations thereof (for instance, for object identification or image, text, speech recognition) and the models thereof can be given. Contribution of the neural network model layers to the correct classification and calculation of the correct estimation proportions, in other words, the calculation of the accuracy can be realized by means of various methods in the present art.

In the present art, the pre-trained neural network models obtained from model servers can be presented to the end users by means of client devices. The users can realize estimation and classification by using these models in the client devices and can improve the performance of the model by training and weight updates. The users upload the different versions of the developed models to the model servers again. As the number of versions increases, the storage area occupied in the model server or in any memory increases. Even if the models are in compressed form, compression does not provide sufficient savings as most of the data is binary. Moreover, transfer (uploading or downloading) of the models, usually with increased size, takes substantial time and consumes high network bandwidth.

As a result, because of the abovementioned problems, an improvement is required in the related technical field.

### SUMMARY

The present invention relates to a system and a model management method realized by said system, for eliminating the abovementioned disadvantages and bringing new advantages to the related technical field.

An object of the present invention is to provide a system and method where the storage space occupied by the different versions of neural network models is reduced.

Another object of the present invention is to provide a method and system which reduces network bandwidth capacity use during transfer of the neural network models among the model servers and clients.

In order to realize the abovementioned objects and the objects which are to be deducted from the detailed description below, the present invention is a system including at least one model server which allows at least one client device to download at least one of pluralities of pre-trained neural network models including pluralities of pre-trained layers in a model database and to upload said models to the model database. Accordingly, the improvement of the present invention is that a proxy unit, which has at least one processor unit, is provided between said model server and said client devices; said processor unit is configured to realize the steps of:
accessing the neural network models,
in case the client device requests a neural network model, transmitting said neural network model to the client device,
in case the client device requests uploading of an edited neural network model, including at least one modified layer where the client device made change, to the model server, uploading only said modified layers to the model database.

Thus, only the modified layers of the neural network models are added to the model database, and the versions of the models occupy substantially reduced amount of place in the model database. In addition to these, the transfer learning and also the operational machine learning models are easily managed.

In a possible embodiment of the present invention, the processor unit is configured to realize the following steps after the step of “accessing the neural network models”:
receiving the neural network models from the server and recording said neural network models to a memory unit,
accessing the metadata of the recorded neural network models in a layer-based manner,
recording the accessed metadata to a control table.

In another possible embodiment of the present invention, the processor unit is configured to realize the following steps:
in case the client unit requests a neural network model, querying through the control table whether the neural network model is recorded in the memory unit or not, transmitting the neural network model to the client device in case it is detected that the neural network model is recorded, and receiving the neural network model from the model server and transmitting the neural network model to the client device in case it is detected that the neural network model is not recorded.

In another possible embodiment of the present invention, the processor unit is configured to repeat the step of “receiving the neural network models from the server and recording said neural network models to a memory unit” at predetermined periods and to update the neural network models in the memory unit.

In another possible embodiment of the present invention, the processor unit is configured to receive the neural network models, transmitted to the client devices, to the cache memory.

In another possible embodiment of the present invention, the processor unit is configured to apply parsing process to the neural network models, fetched to the cache memory, in order for them to be used in the future.

In another possible embodiment of the present invention, the processor unit is configured to transmit only the layers of the neural network model which are changed after a pre-selected date, where the neural network model is requested by the client device.

In another possible embodiment of the present invention, the client device is configured to detect the modified layers and to transmit the modified layers to the processor unit.

In another possible embodiment of the present invention, the client device is configured to determine the values of the predetermined parameters of the modified layers and to transmit the modified layers to the processor unit according to a priority order formed according to the parameter values.

In another possible embodiment of the present invention, said parameter is at least one of size and layer accuracy. Thus, the usage efficiency of data transfer capacity of the client device is increased. For instance, the smaller-sized, modified layers with substantially increased accuracy and precision are transmitted in a prioritized manner compared to the bigger-sized, modified layers with lower precision.

In another possible embodiment of the present invention, the client device is configured to form hash values for the layers of the neural network model fetched from the processor unit and to detect the changed layers by comparing said hash values with the hash values of the layers of the changed neural network model. Thus, the modified layers are detected in an accelerated manner.

In another possible embodiment of the present invention, the processor unit is configured to determine the hash values of the layers of the neural network model, and in case it receives a request indicating that the edited neural network model, whereon the client device made change, is desired to be uploaded to the model server, to query the hash values of the layers of the neural network model desired to be transmitted from the client device and to detect the modified layers and to request transmitting of at least one of the modified layers from the client device.

In another possible embodiment of the present invention, the processor unit is configured to detect the hash values of the layers of the neural network models and in case it receives a request indicating that the network model, changed by the client device, is desired to be uploaded to the model server, to receive the neural network model desired to be transmitted, and to determine the hash value of the layers of the fetched neural network model and to determine the changed layers and to upload the determined changed layers to the model database.

In another possible embodiment of the present invention, said proxy unit is provided in the model server.

In another possible embodiment of the present invention, said proxy unit is a server.

In another possible embodiment of the present invention, said proxy unit is an edge device and/or the client devices are the Internet of Things (IoT) devices. Thus, the revised models are uploaded by means of devices having low processing capacity efficiently.

The present invention is moreover a model management method for a system including at least one model server which allows at least one client device to download at least one of pluralities of pre-trained neural network models including pluralities of pre-trained layers in a model database and to upload said models to the model database. Accordingly, the improvement of said model management method is that it is configured to realize the steps of:
accessing the neural network models,
in case the client device requests a neural network model, transmitting said neural network model to the client device,
in case the client device requests uploading of the edited neural network model, including at least one modified layer where the client device made change, to the model server, uploading of only said modified layers to the model database.

In another possible embodiment of the present invention, after the step of “accessing the neural network models”, the following steps are provided:
receiving the neural network models from the server and recording the neural network models in a memory unit,
accessing the metadata of the recorded neural network models in a layer-based manner,
recording the accessed metadata to a control table.

In another possible embodiment of the present invention, in case the client unit requests a neural network model, it is queried in the control table whether the neural network model is recorded in the memory unit or not, and the neural network model is transmitted to the client device in case it is detected that the neural network model is recorded in memory, otherwise the neural network model is fetched from the model server and the neural network model is transmitted to the client device.

In another possible embodiment of the present invention, the step of “fetching the neural network models from the server and recording the neural network models in a memory unit” is repeated at predetermined periods and the neural network models in the memory unit are updated.

In another possible embodiment of the present invention, the neural network models, transmitted to the client devices, are fetched to the cache memory.

In another possible embodiment of the present invention, parsing process is applied to the neural network models, fetched to the cache memory, in order for them to be used in the future.

In another possible embodiment of the present invention, only the layers of the neural network model which are subject to change after a pre-selected date as requested by the client device are transmitted to the client device.

In another possible embodiment of the present invention, the values of the predetermined parameters of the modified layers are determined by the client device and the modified layers are transmitted to the model server according to a priority order formed according to the values of the parameters.

In another possible embodiment of the present invention, said parameter is at least one of size and layer accuracy. Thus, transfer learning is also improved.

In another possible embodiment of the present invention, the hash values of the layers of the neural network models are determined, the changed layers are detected by querying the hash information of the layers of the neural network model desired to be transmitted from the client device in case it receives a request from the client device indicating that the edited neural network model is desired to be uploaded to the model server, and the processor unit is requested to transmit at least one of the changed layers.

In another possible embodiment of the present invention, the hash values of the layers of the neural network models are determined, the neural network model which is desired to be transmitted is fetched in case it receives a request indicating that the client device desires to upload the neural network model to the model server, the hash value of the layers of the fetched neural network model is determined and the changed layers are determined and the determined changed layers are uploaded to the model database.

### BRIEF DESCRIPTION OF THE DRAWINGS

In FIG. 1, a representative view of a prior art system including model server and client devices of the prior art is given.

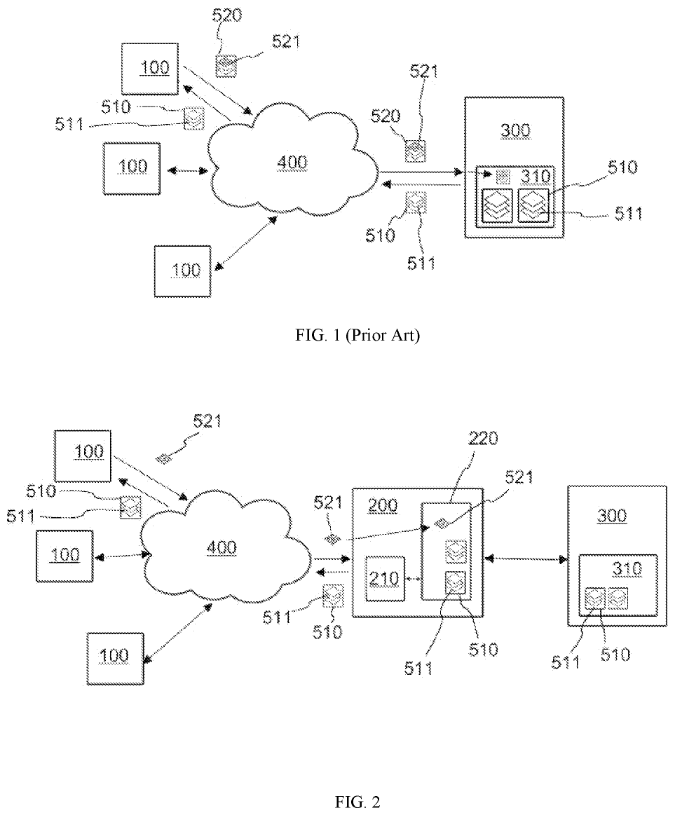

In FIG. 2, a representative view of the subject matter system is given.

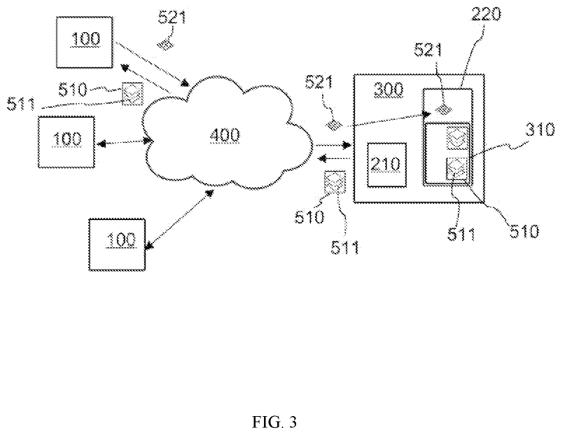

In FIG. 3, a representative view of a possible embodiment of the subject matter system is given.

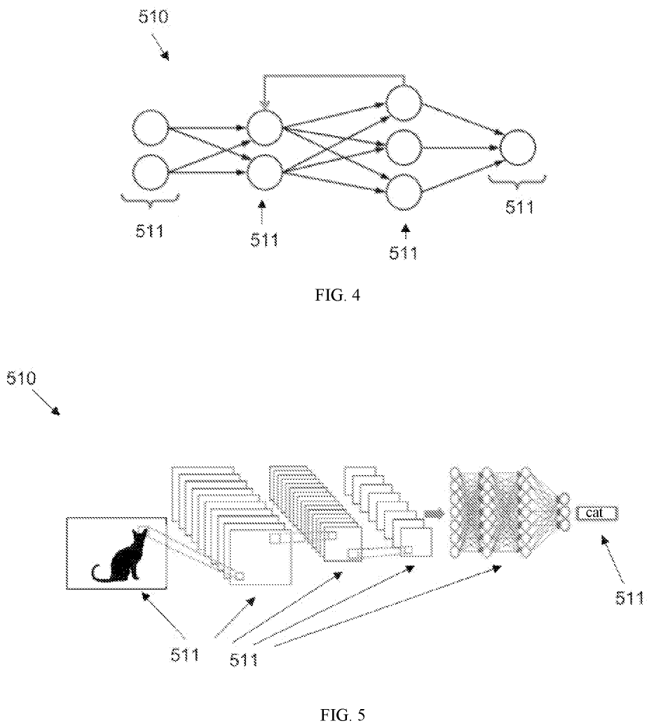

In FIG. 4, a representative view of the neural network model and the layers thereof is given.

In FIG. 5, a representative view of the neural network model, which realizes object identification, and of the layers of said neural network model is given.

### REFERENCE NUMBERS

100 Client device
200 Proxy unit
210 Processor unit
220 Memory unit
300 Model server
310 Model database
400 Communication network
510 Neural network model
511 Layer
520 Edited neural network model
521 Modified layer

### DETAILED DESCRIPTION OF THE EMBODIMENTS

In this detailed description, the subject matter is explained with references to examples without forming any restrictive effect only in order to make the subject more understandable.

With reference to FIG. 2, the present invention is a system and method which provide management of the pluralities of neural network model (510) including more than one pre-trained layer (511) shown as example and thus which provide reduction of the amount of area occupied by said neural network models (510) in the memories. The system is essentially a system and method where after a model is transmitted to a client device (100), only the modified layers (521) of a modified model are carried in the communication medium and stored in the server. Instead of separately recording or carrying the layers (511) repeated at different versions, only the changing/re-trained layers (511) are transferred and stored, and both the transfer medium and the storage area are used in a more efficient manner.

With reference to FIG. 2, in the system in a possible embodiment of the present invention, a proxy unit (200) is provided between the client devices (100) and the model server (300). The client devices (100) and the proxy unit (200) realize data exchange with each other by means of a communication network (400). The server and the proxy unit (200) can be connected to each other by means of a local network or by means of a wide area network like the Internet.

The proxy unit (200) includes a processor unit (210). The processor unit (210) can be a processor like CPU, GPU. The processor unit (210) is associated with a memory unit (220) where data can be read and can be written. The memory unit (220) can include memories which provide permanent storage of data and memories, provide temporary storage of data or the suitable combinations thereof.

The model server (300) includes hardware which is not mentioned here and which is known to belong to model servers (300) in the art. The model server (300) includes a model database (310) where the neural network models (510) are stored. The model database (310) can be provided in one or more than one memory hardware.

The proxy unit (200) can include an input-output unit which provides data exchange with the processor unit (210) which is known in the art but not shown in the figure, network interface hardware which provides connection of the proxy unit (200) to the communication networks, and a data bus which provides suitable communication of the other hardware with each other. In this possible embodiment of the present invention, the proxy unit (200) is a proxy server.

In an alternative embodiment of the present invention as in FIG. 3, the proxy unit (200) is provided in the model server (300). The processor of the model server (300) functions as a processor unit (210) and the memory hardware of the model server (300) also functions as memory unit (220).

In a possible embodiment, the proxy unit (200) is the edge device and the client device is the Internet of Things (IoT) device.

Here, the mentioned client devices (100) include hardware and software which can be connected to the communication network (400) and which can receive and process the neural network models (510) and which can train the layers of the neural network models (510) and which can realize changes at the layers (511). The client devices (100) can for instance be a general-purpose computer.

The innovative characteristic of the present invention is provided due to the processing steps realized when the processor unit (210) of the proxy unit (200) presents the neural network models (510) to the client devices (100) and when the edited neural network models (510) are fetched from the client devices (100).

The processor unit (210) receives neural network models (510) from the model database (310) and records them in the memory unit (220). The processor unit (210) can repeat this process at predetermined periods and can update the memory unit (220) and can receive the missing neural network models (510). The processor unit (210) determines the metadata of each layer (511) of the recorded neural network models (510) and records said metadata in a control table. When a neural network model (510) is requested from the client devices (100), it checks from the control table whether the neural network model (510) exists in the memory unit (220). In case the neural network model (510) exists in the memory unit (220), it transmits the desired neural network model (510) to the client device (100). In case the neural network model (510) does not exist in the memory unit (220), it requests said neural network model (510) from the model server (300) and afterwards, it transmits said neural network model (510) to the client device (100).

Here, the mentioned request can be by means of a URL or GUID. In this case, neural network model (510) can be transmitted from the cache memory.

Here, the mentioned request is realized with the header of “HTTP If-Modified-Since”, the layers (511), which are compliant to the conditions and which are tagged, are transmitted instead of the neural network model (510).

The processor unit (210) records the neural network models (510), transmitted to the client devices (100), in the cache memory. The processor unit (210) moreover parses the recorded neural network models (510) in order to use them later.

The client device (100) can make changes on the fetched neural network model (510) and can train or change various layers (511). The changed layers (511) are defined as modified layer (521) and the neural network model (510), including at least one modified layer (521), is defined as the edited neural network model (510). When the proxy unit (200), in other words when the processor unit (210) receives the request of the client device (100) indicating that the modified neural network shall be uploaded to the model server (300), it provides uploading of only the modified layers (521) to the memory unit (220) and/or to the model database (310) of the model server (300). Thus, the different versions of the neural network models (510) occupy reduced area.

The abovementioned processor unit (210) can record only the modified layers (521) to the memory unit (220) and/or to the model database (310) in different manners in possible embodiments.

In a possible embodiment, the client device (100) is configured to detect the modified layers (521) and to transmit only the modified layers (521) to the processor unit (210). The processor unit (210) receives for instance the modified layers (521) and records the modified layers (521) to the model database (310) by indicating that said modified layers (521) are associated with the other unchanged layers (511) of the related neural network model (510).

The detection of the modified layers (521) can be realized by comparing the hash value of the first version and the hash value of the last version of each layer (511) and by determining the arrangement of the different ones.

In another embodiment, the processor unit (210) records the hash values of each of the layers (511) of the neural network model (510), transmitted to the client device (100), to the control table. When the client device (100) makes the request of transmitting the edited neural network model (510) (520), it requests from the client unit to transmit the hash information of each layer (511) of the edited neural network model (520) desired to be transmitted, and it can detect the modified layers (521) from the hash information and can request that only the modified layers (521) are transmitted.

In another embodiment of the present invention, the processor unit (210) can receive all of the layers (511) from the client device (100) and can detect the modified ones and can provide uploading of said modified ones to the model database (310).

The proxy unit (200) can also change the formats (PB, ONNX, HDF, etc.) or encoding of the files, where the neural network models (510) are recorded, when required.

One of the characteristics of the present invention is that prioritization is realized in the modified layers (521) which are to be recorded to the database. Although some modified layers (521) have very big sizes, the precision increase observed as a result of re-training is low. Thus, instead of uploading such type of modified layers (521), the layers which have smaller size and higher precision are transmitted. In more details, the client device (100) or the processor unit (210) detects the sizes and/or sensitivities of the modified layers (321). Determination of the contributions of the layers (511) to the precision is known in the art. The precision difference between the modified layer (521) and the original layer (511) can be determined. In a possible embodiment of the present invention, the contribution of each modified layer (521) to the precision of the edited neural network model (520) in accordance with the original form can be calculated. A priority list is formed in accordance with the predetermined conditions in accordance with the detected precision value and/or layer (511) sizes, and the modified layers (521) can be modified in order. Afterwards, the modified layers (521) are transmitted to the processor unit (210) in this order and are recorded in the model database (310).

Here, the mentioned conditions can for instance be as follows: the ones with the highest precision change are transmitted before, the ones with the lowest size are transmitted before, the ones having sizes over a specific threshold are not transmitted or said ones are transmitted after predetermined other conditions are met.

The conditions mentioned here can be dynamically determined according to the present communication medium conditions of the client device (100). For instance, when the data transfer bandwidth of the client device (100) decreases, sorting can be realized according to the size.

The neural network models (510) can exist in this form in the database. For instance, a model X can include A, B, C and D layers (511). In the model database (310) or in the memory unit (220), the model X is recorded in an associated manner with these layers (511). When the model X is transformed into a model X′ by arranging layer A (511), the layer A′ (511) associated with the model X′ is recorded in the model database (310), and it accommodates the data indicating that it includes layers B, C and D (511) which are already recorded in the model database (310). When model X′ is desired by the client, layer A′ (511) and the layers B, C, D (511) of the model X can be transmitted to the client device (100). Thus, the layers (511) can be used for more than one model.

In order to be able to realize the present invention, software, related to the method steps formed by command lines, can be uploaded to the client device (100) and/or to the memory unit (220), in a manner realizing the steps of the subject matter method.

The protection scope of the present invention is set forth in the annexed claims and cannot be restricted to the illustrative disclosures given above, under the detailed description. It is because a person skilled in the relevant art can obviously produce similar embodiments under the light of the foregoing disclosures, without departing from the main principles of the present invention.

What is claimed is:

1. A system comprising at least one model server, wherein the at least one model server allows at least one client device to download at least one of pluralities of pre-trained neural network models comprising pluralities of pre-trained layers in a model database and to upload the pluralities of pre-trained neural network models to the model database, wherein a proxy unit has at least one processor unit, is provided between the at least one model server and the client devices; the at least one processor unit is configured to realize the steps of:
accessing the neural network models,
wherein the at least one client device requests a neural network model, transmitting the neural network model to the at least one client device,
wherein the at least one client device requests an uploading of an edited neural network model, comprising at least one modified layer where the at least one client device made change, to the at least one model server, uploading only the modified layers to the model database.

2. The system according to claim 1, wherein the at least one processor unit is configured to realize the following steps after the step of “accessing the neural network models”:
fetching the neural network models from the at least one model server and recording the neural network models to a memory unit,
accessing metadata of the recorded neural network models in a layer based manner,
recording the accessed metadata to a control table.

3. The system according to claim 2, wherein the at least one processor unit is configured to realize the steps of:
wherein a client unit requests a neural network model, querying through the control table whether the neural network model is recorded in the memory unit or not, transmitting the neural network model to the at least one client device, wherein it is detected that the neural network model is recorded, and fetching the neural network model from the at least one model server and transmitting the neural network model to the at least one client device, wherein it is detected that the neural network model is not recorded.

4. The system according to claim 2, wherein the at least one processor unit is configured to repeat the step of “fetching the neural network models from the at least one model server and recording the neural network models to the memory unit” at predetermined periods and to update the neural network models in the memory unit.

5. The system according to claim 1, wherein the at least one processor unit is configured to fetch the neural network models, transmitted to the client devices, to a cache memory.

6. The system according to claim 5, wherein the at least one processor unit is configured to apply a parsing process to the neural network models, fetched to the cache memory, in order for the neural network models to be used in the future.

7. The system according to claim 1, wherein the at least one processor unit is configured to transmit only the layers of the neural network model which, wherein the layers of the neural network model are changed after a pre-selected date, where the neural network model is requested by the at least one client device.

8. The system according to claim 1, wherein the client device is configured to detect the modified layers and to transmit the modified layers to the at least one processor unit.

9. The system according to claim 1, wherein the at least one client device is configured to determine the values of the predetermined parameters of the modified layers and to transmit the modified layers to the at least one processor unit according to a priority order formed according to the values of the predetermined parameters.

10. The system according to claim 9, wherein the predetermined parameter is at least one of a size and a layer accuracy.

11. The system according to claim 7, wherein the at least one client device is configured to form one each hash values for the layers of the neural network model fetched from the at least one processor unit and to detect the changed layers by comparing the hash values with the hash values of the layers of the changed neural network model.

12. The system according to claim 1, wherein the at least one processor unit is configured to determine hash values of the layers of the neural network model, and wherein the neural network model receives a request indicating that the edited neural network model, whereon the at least one client device made change, is desired to be uploaded to the at least one model server, to query the hash values of the layers of the neural network model desired to be transmitted from the at least one client device and to detect the modified layers and to request transmitting of at least one of the modified layers from the at least one client device.

13. The system according to claim 1, wherein the at least one processor unit is configured to detect hash values of the layers of the neural network models, and wherein the neural network model receives a request indicating that the neural network model, changed by the at least one client device, is desired to be uploaded to the at least one model server to fetch the neural network model desired to be transmitted, and to determine the hash value of the layers of the fetched neural network model and to determine the changed layers and to upload the determined changed layers to the model database.

14. The system according to claim 1, wherein the proxy unit is provided in the at least one model server.

15. The system according to claim 1, wherein the proxy unit is a server.

16. The system according to claim 1, wherein the proxy unit is an edge device and/or the client devices are the Internet of Things (IoT) devices.

17. A model management method for a system comprising at least one model server, wherein the at least one model server allows at least one client device to download at least one of pluralities of pre-trained neural network models comprising pluralities of pre-trained layers in a model database and to upload the pluralities of pre-trained neural network models to the model database, wherein the following steps are provided:
accessing the neural network models,
wherein the at least one client device requests a neural network model, transmitting the neural network model to the at least one client device,
wherein the at least one client device requests an uploading of an edited neural network model, comprising at least one modified layer where the at least one client device made change, to the at least one model server, uploading of only the modified layers to the model database.

18. The model management method according to claim 17, wherein after the step of “accessing the neural network models”, the following steps are provided:
fetching the neural network models from the at least one model server and recording the neural network models in a memory unit,
accessing metadata of the recorded neural network models in a layer based manner,
recording the accessed metadata to a control table;
wherein a client unit requests a neural network model, it is queried in the control table whether the neural network model is recorded in the memory unit or not, and the neural network model is transmitted to the at least one client device, wherein it is detected that the neural network model is recorded, and the neural network model is fetched from the at least one model server and the neural network model is transmitted to the at least one client device, wherein it is detected that the neural network model is not recorded;
wherein the step of “fetching the neural network models from the at least one model server and recording the neural network models in the memory unit” is repeated at predetermined periods and the neural network models in the memory unit are updated;
wherein the neural network models, transmitted to the client devices, are fetched to a cache memory;
wherein a parsing process is applied to the neural network models, fetched to the cache memory, in order for the neural network models to be used in the future;
wherein only the layers of the neural network model are transmitted to the at least one client device, wherein the layers of the neural network model are subject to change after a pre-selected date as requested by the at least one client device;
wherein values of predetermined parameters of the modified layers are determined by the at least one client device and the modified layers are transmitted to the at least one model server according to a priority order formed according to the values of the predetermined parameters;
wherein the predetermined parameter is at least one of a size and a layer accuracy.

19. (canceled)

20. (canceled)

21. (canceled)

22. (canceled)

23. (canceled)

24. (canceled)

25. (canceled)

26. The model management method according to claim 18, wherein the following steps are provided:
determining hash values of the layers of the neural network models,
detecting changed layers by querying hash information of the layers of the neural network model desired to be transmitted from the at least one client device, wherein the neural network model receives a request from the at least one client device indicating that the edited neural network model is desired to be uploaded to the at least one model server, and requesting from the processor unit to transmit at least one of the changed layers.

27. The model management method according to claim 18, wherein hash values of the layers of the neural network models are determined, the neural network model is fetched, wherein the neural network model is desired to be transmitted, wherein the neural network model receives a request indicating that the at least one client device desires to upload the neural network model to the at least one model server, the hash value of the layers of the fetched neural network model is determined and the changed layers are determined and the determined changed layers are uploaded to the model database.
